(19) United States
(12) Patent Application Publication
(10) Pub. No.: US 2007/0043558 A1
(43) Pub. Date: Feb. 22, 2007

(54) Priority-Based Resource Allocation

(76) Inventors: Uwe Schwarz, Veikkola (FI); Tony Hulkkonen, Helsinki (FI); Sanjay Bhasin, Espoo (FI); Ahti Muhinen, Hirvihaara (FI); Harri J. Pekonen, Raisio (FI); Ilkka Westman, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/463,666

(22) Filed: Aug. 10, 2006

(30) Foreign Application Priority Data
Aug. 22, 2005 (EP) 05018202.1

(51) Int. Cl. G10L 11/04

(52) U.S. Cl. 704/207

(57) ABSTRACT

The present invention relates to a resource allocation method, network controller device and a switching control device allocating resources to a subscriber of a communication network, wherein at least one allowed codec type is selected for the subscriber based on a relative priority information received from the communication network, e.g., from the switching control device (40). The selected at least one allowed codec type is signaled towards a terminal device (10) of the subscriber. Thereby, priority-based user differentiation can be introduced to provide different quality of service based on the allocated relative priority. This allows maintaining high quality services even in high load or low signal strength environments.

### FIELD OF THE INVENTION

The present invention relates to a method, network controller device, switching control device and computer program product for allocating resources to a subscriber of a communication network.

### BACKGROUND OF THE INVENTION

Operators with growing subscriber base can face significant costs to expand their networks coverage in rural areas and increase capacity in urban settings to meet rising demand.

In GSM (Global System for Mobile communication) systems, by implementing a so-called Adaptive Multi Rate (AMR) Codec, network improvements can be achieved quickly and with lower cost because no additional hardware investment is needed. AMR will cut future operating expenses by reducing the need to build new base station sites. In UMTS (Universal Mobile Telecommunications System), networks support the above AMR codec, because it is a mandatory codec.

As an example, an AMR speech codec is described in 3GPP (3rd Generation Partnership Project) specification TS1 26 071 V6.0.0 and consists of a multi-rate speech coder, a source controlled rate scheme including a voice activity detector and a comfort noise generation system, and an error concealment mechanism to combat effects of transmission errors and lost packets. The multi-rate speech coder is a single integrated speech codec with eight source rates from 4.75 kbps to 12.2 kbps, and a low rate background noise encoding mode. The speech coder is capable of switching its bit rate every 20 ms speech frame upon command. AMR thus tailors the speech codec bit rate and channel coding to fit the radio environment. It can be used to improve speech quality, increase radio network capacity, or both. AMR Full Rate increases speech quality under severe radio conditions. AMR Half Rate provides substantially better speech quality than the standard Half Rate speech codec. This balance of quantity and quality makes AMR Half Rate an attractive alternative for increasing radio capacity.

The superior radio performance of AMR Full Rate and AMR Half Rate results from a dynamic increase in error correction. In poor network conditions when high numbers of errors occur, more bits are used for error correction to obtain robust coding. However, when transmission conditions are good, fewer bits are needed for error protection and more can be allocated for speech coding.

Using an advanced algorithm, AMR dynamically switches between the GSM Full Rate traffic channel with a gross bit rate of 22.8 kbps and the GSM Half Rate traffic channel with a gross bit rate of 11.4 kbps. AMR also moves between different error correction levels within AMR Full Rate and AMR Half Rate. The network dynamically chooses the AMR Full Rate or AMR Half Rate codec for each call. At high traffic loads the network uses AMR Half Rate extensively. When the network is less busy, it assigns AMR Full Rate coding to as many calls as possible, starting with those experiencing the purest radio conditions.

The network also chooses the best error correction level within AMR Full Rate and AMR Half Rate to achieve best call quality. This process, known as codec mode adaptation, results in improved voice quality throughout the cell and increases overall coverage, but is especially noticeable at cell edges and deep inside buildings.

These techniques provide the operator with extra capacity during busy periods and improved quality and coverage when the network is less busy.

Under high load conditions, AMR enables the network to provide service to more subscriber traffic from the same number of base station sites with voice quality even exceeding that of conventional codecs. In poor network conditions when interference is high, AMR dynamically shifts to Full Rate to achieve more robust coding that improves voice quality. In frequency limited networks, operators can gain greatest cost savings because they can plan more transceivers per site to significantly reduce the number of additional base station sites needed.

In general, AMR can be quickly implemented in the network simply by updating the Base Station Subsystem (BSS) software, which costs significantly less than installing additional base station hardware to provide extra capacity.

Until recently, operators and investors measured success by the number of cumulative customers. Network growth was phenomenal, but not always accompanied by comparable increases in Average Revenue Per User (ARPU), which declined for some operators. As a result, the industry has adopted ARPU as a new yardstick for success.

However, emerging markets, like China, India, Brazil, Russia, etc., have tremendous growth potential in mobile communication. In those countries, many potential subscribers are low ARPU users, while a few subscribers generate high ARPU. The network operator thus wants to offer best possible service to these high ARPU subscribers and acceptable service to more price sensitive users. In this case, the AMR network capacity boosting feature leads to the problem that speech codecs are downgraded to lower bit rates due to the resulting increased network load.

### SUMMARY OF THE INVENTION

It is therefore an object of the present invention to provide a resource allocation scheme, by means of which best quality can be provided to high ARPU users and acceptable quality to the low ARPU users.

This object is achieved by a method of allocating resources in a communication network, comprising the steps of:
allocating a relative priority to a subscriber of the communication network;
selecting at least one allowed codec type based on the allocated relative priority; and
using the selected at least one allowed codec type for processing a communication stream exchanged between the communication network and a terminal device of the subscriber.

Furthermore, the above object is achieved by a network controller device for allocating resources to a subscriber of a communication network, the network controller device comprising:
codec selection means for selecting at least one allowed codec type for a subscriber based on a relative priority information received from the communication network; and
signaling control means for signaling the selected codec type towards a terminal device of the subscriber.

Additionally, the above object is achieved by a switching control device for use in a communication network, the switching control device comprising:
priority allocating means for allocating a relative priority to a subscriber of the communication network; and
signaling means for signaling a priority information indicating the allocated relative priority to a radio controller device in a radio resource allocation request message.

Finally, the above object is achieved by a computer program product comprising code means for producing the above selecting step and using step of the allocation method, when run on a computer device. Thereby, the proposed solution can be implemented simply by introducing new software routines at the respective network controller device. This significantly reduces cost of implementation.
Accordingly, the allocated relative priority in connection with the priority based selection of allowed codec types provides the advantage that users can be differentiated, so that high quality service can be provided to demanding subscribers, while lower quality can be provided through less demanding subscribers. Without being able to lower costs for less demanding people mobile services might not at all be possible for many of them. Moreover, the proposed resource allocation scheme is advantageous in that high quality can selectively be provided without the need of general capacity enhancements in the network. Moreover, new technologies like wideband voice codecs (e.g. WB-AMR) and packet based voice (VoIP) will provide additional levels of mobile voice quality. Providing new top level voice quality only to the most valuable mobile subscribers will help to generate a new end-user experience without extensive new network investment but still enhancing the operator brand by having the newest and best technology available. Advantages are thus: higher and more differentiated service quality
easy cost control
retaining valuable high-end subscribers
providing low-end subscribers an affordable and good enough service
thus increasing subscriber growth and revenues
increasing operator brand

The same can be naturally also applied to video codecs, e.g. for video telephony or video streaming.

The different speech quality levels may then form the basis of differential pricing that may be offered to these two different segments of users. All this is accomplished to satisfy the needs of the two different types of users, accommodating a larger number of users and voice traffic in the network and limited further investments in the network equipment. The priority, among other things, could be based on the price that the user is paying for the service;

The relative priority may define a priority class linked to at least one of a plurality of codec bit rates which specify the allowed codec type. As an example, the allowed codec type may be selected from a plurality of adaptive Multi Rate codec modes, such as those provided in the AMR codec.

Furthermore, the relative priority may be allocated by setting a corresponding information in an allocation table. This allocation table may for example be stored in a subscriber data base.

The selection of the at least one allowed codec type may be performed based on a load situation of the communication network.

As an additional measure, a value of relative priority used in resource allocation may be changed to a level higher than the level of said allocated relative priority, if a level of relative priority allocated at a calling end of the connection is higher than the level of said allocated relative priority.

The signaling control means of the network controller device may be adapted to extract the relative priority information from a received bearer allocation signaling. This bearer allocation signaling may be transmitted by the switching control device after incorporating the priority information.

The network controller device may be a base station controller device or a radio network controller device.

Furthermore, the priority allocating means of the switching control device may be adapted to access the allocation table in order to retrieve the relative priority. Additionally, setting means may be provided in the switching control device for setting the allocation table. In particular, the allocation table may provide a mapping between priority values and codec types, or e.g. a mapping between IMSI range and relative priority values, or both of these mappings. As an example, the switching control device may have provided at least one table which may comprise the following information:
mapping between relative priorities and at least one allocated codec type, as required by the switching control means (e.g. MSC) to know which are the allowed codecs for users assigned with a particular relative priority;
mapping between CS Allocation/Retention priorities (HLR-MSC interface) and a relative priority (MSC-BSC/RNC interface) required for subscriber specific codec selection, while the subscriber category could be specified by any parameter in the HLR-MSC interface;
mapping between IMSI ranges and relative priorities, which may optionally be required if no priority value is received from HLR.

According to a possible scenario, good quality codecs can be allocated also for low-priority users, e.g. mass-market users, as long as the network load or cell load is relatively low. Then, at some point, the load increases above predetermined threshold level, so that the available resources would no longer allow an appropriate codec to be allocated for high-priority users. If this load threshold is determined to be exceeded, the network decides to change the type of codec used for at least one low-priority user so as to increase available network resources. The new codec is then indicated by the network to the terminal device of the concerned user.

The system or method may be adapted to provide a function or functionality, according to which the subscriber's relative priority may influence values used for other network parameters, such as Preemption Capability, Preemption Vulnerability, and/or Queuing.

The switching control device may be a mobile switching center.

Further advantageous modifications are disclosed below.

### BRIEF DESCRIPTION OF THE DRAWINGS

The present invention will now be described based on embodiments with reference to the accompanying drawings in which:

FIG. 1 shows a schematic block diagram of a network architecture in which the present invention can be implemented;

FIG. 2 shows a schematic block diagram of an implementation of the present invention in a GSM architecture, according to a first embodiment;

FIG. 3 shows a schematic block diagram of an implementation of the present invention in a UMTS architecture, according to a second embodiment;

FIGS. 4A and 4B show schematic diagrams indicating different load situations and resulting differentiated codec rates according to the first and second embodiments; and

FIG. 5 shows a general overview of functions and interactions according to the present invention for the first and second embodiments.

### DETAILED DESCRIPTION OF THE EMBODIMENT

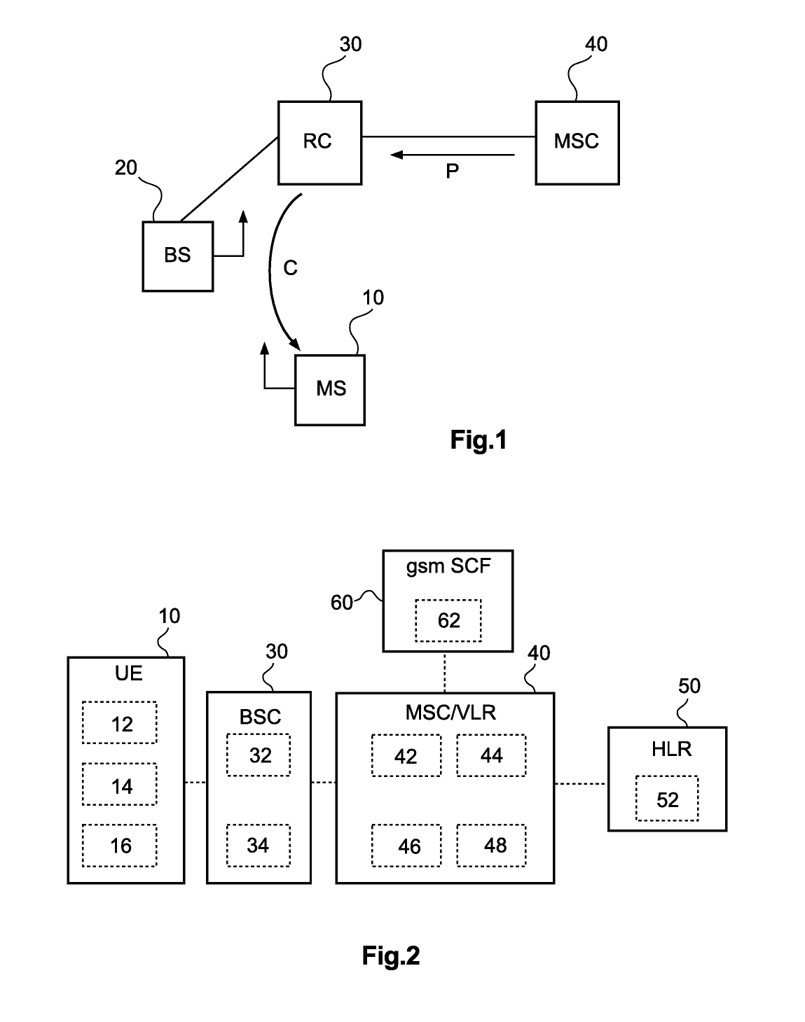

In the following, the first and second embodiments will be described based on a cellular network environment as shown in FIG. 1. A switching control device, such as a mobile switching center (MSC) 40 is a switch that serves a mobile terminal or mobile station (MS) 1 0 in its current location for cellular services. The MSC function is used to switch transactions, while an incorporated subscriber data base function, such as a visitor location register (VLR) function may be provided to hold a piece of a visiting user's service profile.

The MSC/VLR 40 is connected to a radio controller device 30, which may be a radio network controller (RNC) or a base station controller (BSC) and which owns and controls radio resources in its domain. The radio controller device 30 is the service access point for all services the radio access network provides to the core network, such as for example management of connections to the MS 10. In particular, the radio controller device 30 controls at least one base station device 20, which may be a node B in 3rd generation terminology, and which may also participate in radio resource management. The main function of the base station device 20 is to perform air interface L1 (Layer 1) processing, such as channel coding and interleaving, rate adaptation, spreading, etc. The radio controller device 30 is responsible for load and congestion control of its own cells, and also executes admission control and code allocation for new radio links to be established in those cells.

The MS 10 is a radio terminal used for radio communication over the air interface to the base station device 20. It includes a subscriber identity module (SIM) as a smart card which holds the subscriber identity, performs authentication algorithms, and stores authentication and encryption keys and some subscription information that is needed at the terminal.

According to the embodiments, identification of user classes, which may be based upon any kind of discrimination suitable to provide different service priorities, is performed in the radio controller device 30 based on priority values P indicated by the MSC/VLR 40 during setup, e.g., in a bearer allocation signaling. This relative priority information P is taken into account during selection of the speech codec type, class or mode. In addition thereto, network load and signal strength may be taken into account as well. That means, for example, low priority users (e.g. low ARPU users) are provided with a Half Rate speech codec when cell load is high, while high priority users (e.g. high ARPU users) are provided with a Full Rate speech codec which may even never be downgraded due to cell load. The allocated codec type, class or mode may be signaled via the base station device 20 to the MS 10 using a corresponding codec information C.

It is to be noted here that the present invention can be applied to any adaptive coding functions and are not limited to the initially described AMR speech codec. If, however, the AMR codec is used in the preferred embodiment, different codec types, classes or modes may be mapped or allocated to or associated with the range of priority values available for allocation to the user or subscriber. As an example, priority values may range from a lowest value “14” to a highest value “1”, wherein the corresponding allocated value may be signaled by the MSC/VLR 40 as the priority information P.

FIG. 2 shows a schematic block diagram of a GSM network architecture according to the first embodiment.

An MSC/VLR 40 may be one integrated network element or two separate network elements (MSC Server and Media Gateway) as specified in 3GPP Release 4. In the REL-4 GSM architecture, a Codec Selector for performing a Network Codec Selection function 32 and Transcoder Unit 34 are logically located in a base station controller (BSC) 30, even if the physical location of the Transcoder Unit 34 may be in the Media Gateway (not shown in FIG. 2).

In GSM, a subscriber category parameter sent by an Allowed Codecs Selection function 46 of the MSC/VLR 40 to the Network Codec Selection function 32 may be a priority parameter (for example as defined in 3GPP TS 48.008, chapter 3.2.2.18). It may have values from “1” (highest priority) to “14” (lowest priority). Alternatively it could be some not yet standardized new parameter representing subscriber category, or a proprietary parameter.

Furthermore, in GSM, it is the Network Codec Selection function 32 which indicates the selected codec to a UE Codec Selection function 14 at a UE (user equipment) 10, which is the 3G equivalent of the above MS of FIG. 1.

The Network Codec Selection function 32 uses the GSM Radio Resource protocol to indicate the selected codec parameter and the other parameters (e.g. codec mode, data rates) as specified in 3GPP TS 44.018.

The MSC/VLR 40 comprises a signaling unit arranged for generating and exchanging signaling messages with the radio access network, in particular with the BSC 30. Furthermore, a priority allocation functionality or unit may be provided in the MSC/VLR 40 or alternatively in an associated subscriber database (e.g. Visitor Location Register VLR) which allocates a relative priority to a subscriber based on a subscriber information retrieved or read from an internal allocation table provided in a visited subscriber category database 48 and/or from an external subscriber category data base 52 provided in an external subscriber database, such as a Home Location Register (HLR) 50. The subscriber information may directly indicate the allocated priority or may indicate subscriber category or subscriber class in another subscriber data parameter based on which a priority can be allocated using a specific allocation rule or allocation map which may be stored at the MSC/VLR 40 or the subscriber data base 50. The visited subscriber category database 48 or the subscriber category data base 52 may be modified by the network operator by setting the subscriber information based on the user characteristic of the subscriber. As an example, the ARPU or another subscriber characteristic can be set to thereby allocate a corresponding priority to a specific subscriber.

The radio controller device, e.g. BSC 30, which comprises a signaling control unit 33 arranged for receiving signaling messages from the MSC/VLR 40, such as the bearer allocation signaling including the priority information P. The signaling control unit 33 extracts the priority information P from the bearer allocation signaling and supplies the priority information to the Transcoder Unit 34, which may comprise the AMR speech codec, in which a corresponding codec type, class or mode is selected based on the received priority information P. Additionally, network load information L or signaling strength information S received from the network may be considered during selection. The Transcoder Unit 34 returns a codec information indicating at least one codec type, class or mode or a codec list or a codec range to the signaling unit which signals this codec information C via the base station device 20 (not shown in FIG. 2) to the UE 10 in order to negotiate a codec processing used for exchanging data.

As an example, high ARPU users or users with high priority may be provided with a codec range excluding specific codec types, classes, or modes with low speech quality or low quality codec in case of load adaptation. On the other hand, coverage enhancement depending on the signal strength information S may be arranged, so that even codec types, classes or modes with low quality are selected for high priority users. Thus, different codec selection properties may be used in dependence on the network load information L and/or the signal strength information S. Of course, other network parameters which determine codec behavior can be used or considered as well or alternatively during codec selection.

As already mentioned above, the identification of user classes in the radio controller device 30 can be based on priority values “1” to “14” indicated by the received priority information. In case the called party is a low priority user (e.g. low ARPU user), the MSC/VLR 40 serving the called party may be adapted to replace the priority value of the called low priority user by a priority value representing a high priority user in case the calling party is a high priority user (e.g. high ARPU user). A parameter representing the calling party's relative priority (e.g. high, medium, low) may have been signaled from the MSC serving the calling party. It is noted that the priority information provided in the interface between the MSC/VLR 40 and the BSC 30 and the priority information provided in the interface between different MSC/VLRs may not have the same value range, i.e. priority information which the MSC/VLR 40 provides to the BSC 30 may differ from the priority information which the MSC/VLR of the calling party provides to the MSC/VLR of the called party. As an example of the above scenario, a first network may use a relative priority value “3” for premium subscribers and a value “5” for mass-market subscribers. A second network may use relative priority value “7” for premium subscribers and value “9” for mass-market subscribers. Now, a premium subscriber in the first network calls a mass-market subscriber in the second network. Based on the information received from the first network, the second network assigns a relative priority value “7” with higher priority level for the mass-market user, instead of value “9” with lower priority level, as it normally would, and uses it (or a derivative of it) in the codec selection.

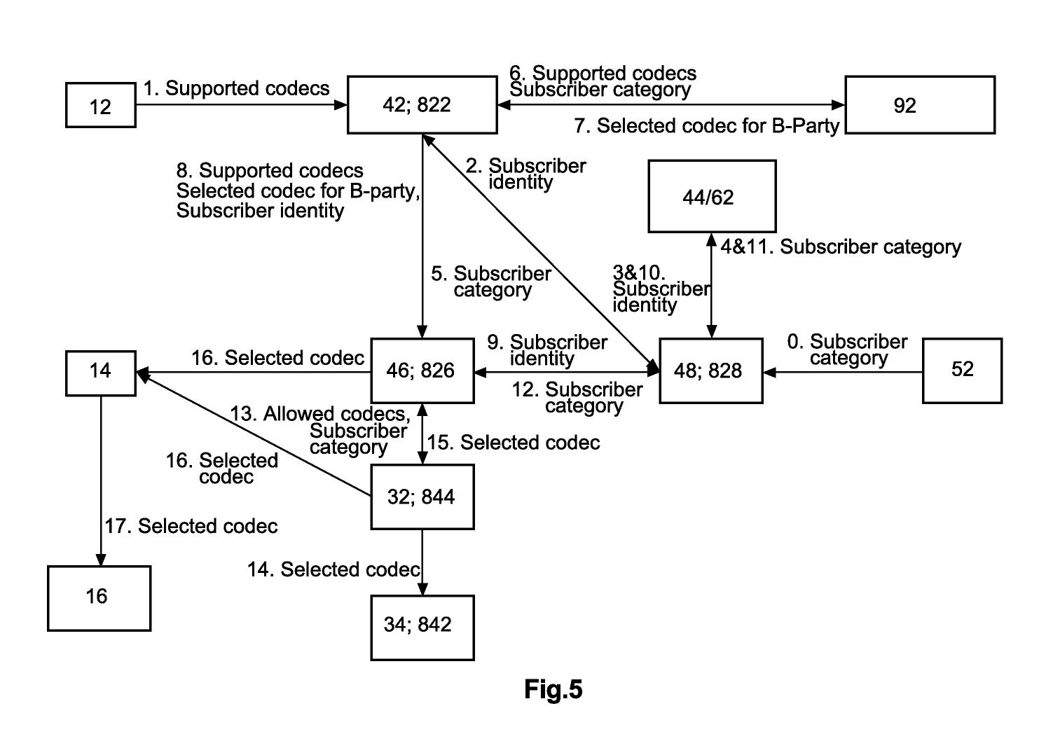

Further details of the blocks and functions of FIG. 2 are described later in connection with FIG. 5.

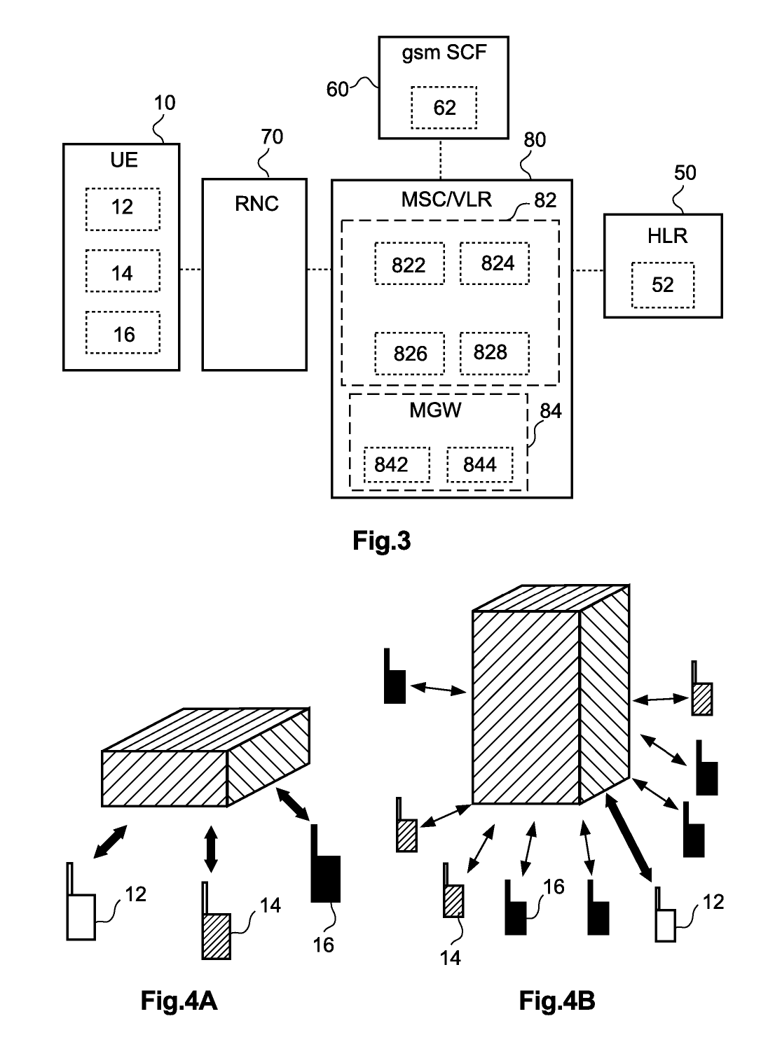

FIG. 3 shows a schematic block diagram of a UMTS network architecture according to the second embodiment.

It is noted that also the UMTS MSC/VLR 80 of FIG. 3 may be one integrated network element or two separate network elements, i.e., MSC Server 82 and Media Gateway (MGW) 84 as specified in 3GPP Release 4 and indicated in FIG. 3.

In the present UMTS-based second embodiment, the subscriber category parameter may represent a user's subscriber category, e.g. it may have values which represent Gold/Silver/Bronze, or Premium/Mass-market, or any other operator defined subscriber segmentation scheme. This parameter is an internal parameter to the MSC/VLR 80. In case of 3GPP REL-4 architecture, this parameter may be external to the MSC Server 82 and some proprietary parameter could be used to represent it.

Furthermore, in UMTS, it is an Allowed Codecs Selection function 826 of the MSC Server 82 which indicates the selected codec to the UE Codec Selection function 14 at the UE 10. The selected codec parameter and the other associated codec parameters (e.g. codec mode, data rates) are specified in 3GPP TS 25.413 and 3GPP TS 25.331. The selected codec parameter may be represented e.g. by the NAS Synchronization Indicator parameter as specified in 3GPP TS 25.413 (chapter 9.2.3.18) and 3GPP TS 25.331 (chapter 8.6.4.12).

Further details of the blocks and functions of FIG. 3 are described later in connection with FIG. 5, where similar units or functions of FIGS. 2 and 3 are indicated by the corresponding reference signs with a slash or semicolon inbetween.

FIGS. 4A and 4B show schematic diagrams indicating network load as height of a three-dimensional bar, wherein codec quality, e.g. codec bit rate, are indicated by the thickness of arrows arranged between active mobile stations and the network. The color or pattern of the mobile stations indicate their allocated priority. In particular, a white or blank mobile station 12 with no pattern indicates high priority users, a hatched mobile station 14 with a hatched pattern indicates medium priority users, and a black mobile station 16 indicates low priority users. Of course, more than these three different relative priorities may be allocated. The situation shown in FIGS. 4A and 4B mainly serves for explanation purposes.

FIG. 4A indicates a situation with low network load (e.g. only three mobile stations are active in the network). In this case, all users can be provided with the highest quality codec or the highest codec quality due to the low network load. However, if the network load increases significantly, as shown in FIG. 4B by the large height of the three-dimensional bar, codec quality must be reduced or the type of the codec must be changed to be able to serve all mobile stations who access the network. However, according the embodiment, not all mobile station face reduced codec quality, but only the low priority mobile stations 16 and medium priority mobile stations 14. During connection establishment, they received a codec information C which allows only low quality codec classes, types or modes, such that a low quality codec, e.g. AMR Half Rate, can be established. As illustrated in FIG. 4A, also low priority users may be allowed to use high quality codec e.g. when the available network capacity allows it. The point is, that under congestion the low priority users may be switched to use low quality codec while the high priority users continue to use high quality codecs.

FIG. 5 shows a general overview of functions and interactions according to the present invention for the first and second embodiments of FIGS. 2 and 3, respectively.

This overview provides a very high-level access technology agnostic view on how the codec is selected for a user.

The steps of the selection scenario according to the first and second embodiment are described below.

In step 0, at the time when a user has registered to the network, a subset of the subscriber data is transferred from Subscriber Category Database 52 (e.g. at the HLR 50) to the Visited Subscriber Category Database 48/828 (e.g. VLR). Among other information, the subscriber data may contain information which represents the user's relative priority in relation to other users. This parameter is here called Subscriber Category.

At some point (step 1), a user initiates establishment of a call towards the called party and at the same time informs the network about which codecs the user equipment supports (Supported Codecs). In response thereto, a Visited Network Call Control function 42/822, i.e. a call control entity serving the user, may be configured to ask the Visited Subscriber Category Database 48/828 in step 2 about the users subscriber category to enable it to be delivered to a terminating network serving the called party. This would allow the calling party's subscriber category to influence the codec selection of the called party user. E.g., if a high priority user calls a low priority user, a high quality codec could be selected also for the low priority user to increase the quality of the call end-to-end.

If the Visited Subscriber Category Database 48/828 has not received the subscriber category of the user from the Subscriber Category Database 52, the Visited Subscriber Category Database 48/828 may ask either a local IMSI (International Mobile Subscriber Identity) analysis function 44/824 or an external Service Control Function (SCF) 62 provided e.g. by a gsm SCF 60 to provide a subscriber category applicable for the user. A subscriber identity (e.g. IMSI or MSISDN) is then provided in step 3 for these functions. Notice that for the sake of simplicity of FIG. 5 these two functions have been put into the same box.

In step 4, the IMSI analysis function 44/824 or the Service Control Function 62, respectively, returns the subscriber category of the calling party to the Visited Subscriber Category Database 48/828. Then, in step 5, the Visited Subscriber Category Database 48/828 returns the subscriber category of the calling party to the Visited Network Call Control function 42/822.

In step 6, the Visited Network Call Control 42/822 sends a list of supported codecs and the subscriber category to a Terminating Network Call Control function 92. The supported codecs received from the UE 10 and the supported codecs sent are not necessarily the same. E.g., if the network does not support all the codecs supported by the UE 10, the Visited Network Call Control function 42/822 may remove some of the codecs in the list before it sends it forward to the Terminating Network Call Control function 92.

The Terminating Network Call Control function 92 analyzes the received information, the codecs supported by the called user, the codecs supported by the local network, subscriber category of the called party, and selects a codec. The selected codec for B-party (called party) is indicated back to the Visited Network Call Control function 42/822 in step 7. In response thereto, the Visited Network Call Control function 42/822 sends in step 8 information about the supported codecs, the selected codec for B-party, and the subscriber Identity to the Allowed Codecs Selection function 46/826.

To be able to select an appropriate list of allowed codecs for the user, the Allowed Codecs Selection function 46/826 needs to know the subscriber category of the user. Thus, the Allowed Codecs Selection function 46/826 queries in step 9 the subscriber category from the Visited Subscriber Category Database 48/828 by sending the subscriber identity to the Visited Subscriber Category Database 48/828.

The following steps 10 and 11 are identical to the above steps 3 and 4, respectively.

Then, in step 12, Visited Subscriber Category Database 48/828 returns the subscriber category to the Allowed Codecs Selection function 46/826. The Allowed Codecs Selection function 48/828 has a set of allowed codecs lists defined for each subscriber category. Based on the received subscriber category, supported codecs, and selected codec for B-party, it selects the most appropriate allowed codecs list and sends it in step 13 to the Network Codec Selection function 32/844. The Allowed Codecs Selection function 46/826 may also fetch appropriate values from its internal configuration tables for Preemption Capability, Queuing Allowed Indicator, and Preemption Vulnerability Indicator parameters, which may be sent to the radio network during resource allocation phase. Preemption Capability specifies whether this user is allowed to preempt an existing connection. Queuing Allowed Indicator specifies whether the resource allocation of this user can be put into a queue in the radio access network. Preemption Vulnerability Indicator specifies whether this connection may be preempted by a resource allocation procedure of another user.

In step 14, the Network Codec Selection function 32/844 selects the most appropriate codec for the user based on the information received from the Allowed Codecs Selection function 46/826 and the available transcoder resources in the Transcoder Unit 34/842. Then, in step 14, the Network Codec Selection function 32/844 indicates to the Transcoder Unit 34/842 the selected codec, and, in step 15, the Network Codec Selection function 32/844 indicates to the Allowed Codecs Selection function 46/826 the selected codec.

In step 16, either the Allowed Codecs Selection function 46/826 or the Network Codec Selection function 32/844 indicates to the UE Codec Selection function 14 the selected codec. Finally, in step 17 the UE Codec Selection function 14 indicates to a UE Codec Unit 12 the selected codec.

Below, the abstract parameters of the access network independent interfaces used above are explained.

The Subscriber Category parameter represents the user's subscriber category, e.g. it may have values which represent Gold/Silver/Bronze, or Premium/Mass-market, or any other operator defined subscriber segmentation scheme. It can be the CS (circuit switched) Allocation/Retention Priority parameter already standardized in the MSC-HLR interface. It could be also some other e.g. a proprietary (non-standardized) parameter. The only requirement is that MSC/VLR 40/80 knows how to interpret the different values the used parameter may have. The Supported Codecs parameter is defined for example in 3GPP TS 24.008. The Subscriber Identity is an internal parameter to the MSC/VLR 40/80, so that the actual parameter depends on the implementation. For example, it could be IMSI, MSISDN, or some other internally used reference to the user. It is noted however that the Subscriber Category parameter signaled in the above steps 0, 4, 5 and 12 not necessarily are exactly same. They may differ in representation and/or value.

Furthermore, the Supported Codecs parameter is standardized in the relevant call control specifications. There are multiple network-network call control protocols in use, such as ISUP (ISDN User Part). The Subscriber Category parameter could be e.g. ISUP Calling Party Category parameter, or MLPP parameter (Multi-Level Precedence and Preemption), or some proprietary parameter.

Additionally, the Selected Codec for B-party parameter is standardized in the relevant call control specification. Supported Codecs, Selected Codec for B-party, and Subscriber Identity parameters are internal parameters to MSC/VLR 40/80, i.e. it is an implementation issue what kind of representation they have. They can be same as the parameters used in external interfaces or derivatives of them.

In case of communication with the IMSI Analysis function 44/824, the Subscriber Identity parameter is an internal parameter to MSC/VLR 40/80, i.e. it is an implementation issue what kind of representation they have. Typically it would be IMSI or MSISDN. In case of communication with Service Control Function 62, the parameter is external to MSC/VLR 40/80. In this case, the used parameter can be either IMSI or MSISDN.. In case of communication with Service Control Function, the parameter is external to MSC/VLR. In this case, the used parameter is likely a proprietary parameter.

The Allowed Codecs parameter is an internal parameter to MSC/VLR 40/80, i.e. it is an implementation issue what kind of representation they have. Essentially it lists the type of codecs and the associated codec parameters which are subject to subscriber segmentation. Similarly, the Selected Codec parameter is an internal parameter to the network element in which the Network Codec Selection function (block 32 in FIG. 2 and block 844 in FIG. 3) and the Transcoder Unit (block 34 in FIG. 2 and block 842 in FIG. 3) are located. Essentially, it specifies the type of selected codec and the associated other codec parameters. In the above step 15, the Selected Codec parameter specifies the selected codec type and the associated codec parameters for those parameters for which Network Codec Selection function 34/844 has had some freedom to choose. Finally, the Selected Codec parameter of step 17 is an internal parameter to the UE 10. Essentially, it specifies the type of selected codec and the associated other codec parameters.

It is noted that all message sequences and parameters of FIG. 5 are common to the GSM-based first embodiment of FIG. 2 and the UMTS-based second embodiment of FIG. 3, except for the subscriber category of step 13 and the selected codecs of step 16.

In summary, a network operator may define for a subscriber a parameter in the subscriber data in the HLR, which represents subscriber's class/category (e.g. Gold/Silver/Bronze or any other categorization). Then, the user registers to some network and the parameter defined above is transferred from HLR to MSC/VLR. Now, the user establishes a call. The MSC/VLR retrieves the parameter received before and maps it to the user priority parameter. Either using the received parameter or some other parameter derived from it (e.g. user priority, this is an implementation issue), the MSC/VLR retrieves the information regarding allowed codecs and associated other parameters. Finally, in GSM the user priority and allowed codecs (and parameters) are sent to the base station device (BSC) at the resource establishment phase. In UMTS, the user priority and parameters associated with the selected codec are sent to the radio network controller device (RNC).

The user priority is taken into account during codec selection so that codec selection can be based on user priority and optionally other parameters such as load signal strength etc. This kind of user differentiation allows high quality services for selected subscribers, while lower quality service can be provided for less-demanding subscribers. The present invention relates to a resource allocation method, network controller device and a switching control device allocating resources to a subscriber of a communication network, wherein at least one allowed codec type is selected for the subscriber based on a user priority information received from the communication network, e.g., from the switching control device. The selected codec type and the associated other parameters for the codec is signaled towards a terminal device of the subscriber. Thereby, priority-based user differentiation can be introduced to provide different quality of service based on the allocated user priority. This allows maintaining high quality services even in high load or low signal strength environments.

It is noted that the present invention is not restricted to the above embodiment, but can be applied in any network environment where codec functionality can be adapted to a specific network or transmission parameters. Any codec type, class or mode could be selected. There are many different types of AMR codecs, e.g. GSM AMR FR, GSM AMR HR, UMTS AMR, UMTS AMR2, OHR AMR, FR AMR-WB, UMTS AMR-WB, etc. Some of them are for GSM, some are used only in UMTS. The present invention is intended to cover any kind of differentiation associated with the usage of codecs by different subscriber segments. E.g., in UMTS a wideband codec (UMTS AMR-WB) could be assigned for premium subscribers, whereas mass-market subscribers could use a regular UMTS AMR or UMTS AMR2.

Also new codecs are continuously under development, and the present invention is not intended to be restricted to any of the currently available codec types. Generally, the suggested mechanism may allocate a codec with a better speech quality e.g. to premium subscribers and a more spectrally efficient (less bandwidth) codec e.g. to mass-market subscribers. Moreover, the invention is applicable not only in GSM or UMTS, but can be applied as well in other technologies, such as Code Division Multiple Access (CDMA) system, e.g. CDMA2000, or TD-CDMA (Time Divisional CDMA), or Unlicensed Mobile Access (UMA ) systems. In the CDMA case, a subscriber category parameter (e.g. Priority parameter as specified in 3GPP2 A.S0005, or some other parameter) may be used for signaling the priority information. The subscriber category parameter may be received at the base station, i.e. BSC, in an Assignment Request message issued by the MSC. Based thereon, a codec selection function provided in the base station may select a more appropriate codec type. This feature may be adapted as a service option. If the selected codec type differs from the one received from the UE in a mobile originated call or from the network in a mobile terminated call, the base station may send a Service Option Request Order to the UE requesting the codec type (e.g. as a service option) selected by the codec selection function.

The preferred embodiment may thus vary within the scope of the attached claims.

1. A method of allocating resources in a communication network, comprising:
a) allocating a relative priority to a subscriber of said communication network;
b) selecting at least one allowed codec type based on said allocated relative priority; and
c) using said selected at least one allowed codec type for processing a communication stream exchanged between said communication network and a terminal device of said subscriber.

2. A method according to claim 1, wherein said relative priority defines a priority class linked to at least one of a plurality of codec bit rates which specify said allowed codec type.

3. A method according to claim 1, wherein said relative priority is derived from a subscriber category parameter provided in an assignment request message.

4. A method according to claim 2, wherein said allowed codec type is selected from a plurality of codec types and associated codec modes.

5. A method according to claim 1, further comprising allocating said relative priority by setting a corresponding information in an allocation table.

6. A method according to claim 5, further comprising storing said allocation table in a subscriber data base.

7. A method according to claim 1, wherein said selecting is performed based on a load situation of said communication network.

8. A method according to claim 1, further comprising changing a value of relative priority used in resource allocation to a level higher than the level of said allocated relative priority, if a level of relative priority allocated at a calling end of the connection is higher than a level of said allocated relative priority.

9. A method according to claim 1, further comprising changing said selected codec type in response to a determined increase in network load.

10. A method according to claim 1, further comprising controlling a value of at least one other network parameter based on said allocated relative priority.

11. A method according to claim 10, wherein said at least one other network parameter comprises at least one of a preemption capability parameter, a preemption vulnerability parameter, and a queuing allowed parameter.

12. A network controller device for allocating resources to a subscriber of a communication network, said network controller device comprising:
a) codec selector for selecting at least one allowed codec type for a subscriber based on a relative priority information received from said communication network; and
b) signaling control unit for signaling said selected at least one allowed codec type towards a terminal device of said subscriber.

13. A network controller device according to claim 12, wherein said signaling control unit is adapted to extract said relative priority information from a received bearer allocation signaling.

14. A network controller device according to claim 12, wherein said codec selector is adapted to derive said relative priority from a subscriber category parameter signaled in an assignment request message.

15. A network controller device according to claim 12, wherein said signaling control unit is adapted to signal said selected at least one codec type in a service option request order.

16. A network controller device according to claim 12, wherein said codec selector is adapted to select said at least one allowed codec type based on at least one of a load situation and signal strength in said communication network.

17. A network controller device according to claim 12, wherein said codec selector is adapted to change said allocated relative priority if a relative priority allocated at the other connection end is higher than said allocated relative priority.

18. A network controller device according claim 12, wherein said network controller device is a base station controller device or a radio network controller device.

19. A switching control device for use in a communication network, said switching control device comprising:
a) priority allocating unit for allocating a relative priority to a subscriber of said communication network; and
b) signaling unit for signaling priority information indicating said allocated relative priority to a radio controller device in a radio resource allocation request message.

20. A switching control device according to claim 19, wherein said priority allocating unit is adapted to access an allocation table in order to retrieve said relative priority.

21. A switching control device according to claim 19, wherein said signaling unit is adapted to signal said priority information by means of a subscriber category parameter.

22. A switching control device according to claim 19, wherein said priority allocation unit comprises a setting unit for setting said allocation table.

23. A switching control device according to claim 19, wherein said switching control device is a mobile switching center.

24. A computer program product comprising code means embodied in a computer readable medium for producing the steps b) and c) of method claim 1, when run on a computer device.

25. A computer program comprising code embodied in a computer readable medium for allocating resources in a communication network when run on a computer by
selecting at least one allowed codec type based on an allocated relative priority, and
using said at least one allowed codec type for processing a communication stream exchanged between said communication network and a terminal device of a subscriber.

26. The computer program of claim 25 further comprising allocating a relative priority to said subscriber.

27. Apparatus for allocating resources in a communication network, comprising:
a) means for allocating a relative priority to a subscriber of said communication network;
b) means selecting at least one allowed codec type based on said allocated relative priority; and
c) means for using said selected at least one allowed codec type for processing a communication stream exchanged between said communication network and a terminal device of said subscriber.

28. The apparatus according to claim 27, wherein said relative priority defines a priority class linked to at least one of a plurality of codec bit rates which specify said allowed codec type.

29. The apparatus according to claim 27, wherein said relative priority is derived from a subscriber category parameter provided in an assignment request message.
